(19) United States
(12) Patent Application Publication
(10) Pub. No.: US 2015/0101633 A1
(43) Pub. Date: Apr. 16, 2015

(54) DENTAL HYGIENE TOOL AND METHOD

(71) Applicant: Bruce Goldberg, St. Petersburg, FL (US)

(72) Inventor: Bruce Goldberg, St. Petersburg, FL (US)

(21) Appl. No.: 14/494,703

(22) Filed: Sep. 24, 2014

Related U.S. Application Data
(60) Provisional application No. 61/883,272, filed on Sep. 27, 2013.

(51) Int. Cl. A61C 15/02; A61C 15/04

(52) U.S. Cl. CPC A61C 15/02; A61C 15/046
USPC 132/323; 132/321; 29/896.1

(57) ABSTRACT

A dental hygiene for cleaning tool that is small, inexpensive and lightweight to use by people to care for their teeth and gums. The tool has several components integrated or connected with the body of the tool such as a digger for cleaning between teeth. These components include: a floss piece preferably made of nylon and preferably attached to the tool's interiors; a number of rough textures along edges for cleaning between the teeth of varying thicknesses depending on the spacing between the teeth and a curved pick portion adapted to contour over a person's lip when using the tool; a cleaner also for cleaning between the teeth made of a pointed end to clean between teeth and a thinner material for easier insertion between the teeth.

### RELATED APPLICATIONS

The present application is non provisional application of provisional application Ser. No. 61/883,272 filed by Bruce Goldberg on Sep. 27, 2013.

### BACKGROUND

1. Field

The present invention relates to a dental hygiene tool and method. In particular the present invention relates to a method and a dental hygiene tool that is approximately the size and thickness of a credit card and that is an advanced, transportable tooth cleaning device featuring several cleaning options. The present invention provides for a method and a dental tooth cleaning tool that is small, inexpensive and lightweight to use by people to care for their teeth and gums.

2. The Related Prior Art

U.S. Pat. No. 3,101,727 to WISEMAN in FIGS. 1,4 show a toothpick that includes an oblong disc-like body 1, flat sides giving rectangular appearance and protuberances 4 formed on bottom of said recesses which will contribute degree of firmness which device is gripped, 2: 30+; toothpick 8 from edge 5; at the other end is second toothpick 14. This pick is form of a straight knife blade; blade 14 conforms to the outline of the inter-dental spaces with the sharp edge 16 directed away from the gum so that the flat back edge 17 will massage gum rather than tend to cut into it when the blade is inserted between the teeth, (3:1+).

U.S. Pat. No. 6,526,993 to Wagner in FIG. 1 relates to a dental implement 10 that includes an elongate body 12 formed of a suitable polymer. At one end of the body 12 there is provided a dental tool 14 comprising a curved pick while the other end of the body is formed with a wedge shaped pick 16. In accordance with the invention, affixed to the body 12 between the tools 14, 16 there is a grip 18; the faces may be shaped in various geometric configurations suitable for being grasped, e.g. square (FIG. 1), rectangular (FIG. 6) or circular (FIG. 7); (4:15+; FIG. 6), an alternate implement 10c comprising a body 12c with a dental tool 14c at one end thereof. The dental tool 14c is configured as a dental floss holder and applicator. Pursuant to the invention, a comfit grip 18c, (4:54+).

### SUMMARY

The present invention provides for a method and a dental hygiene cleaning tool that is small, inexpensive and lightweight to use by people to care for their teeth and gums. The tool as described in the attachments with which you furnished us has several components integrated or connected with the body of the tool such as a digger for cleaning between teeth; a floss piece preferably made of nylon and preferably attached to the tool's interiors; a number of rough textures along edges for cleaning between the teeth of varying thicknesses depending on the spacing between the teeth and a curved pick portion adapted to contour over a person's lip when using the tool; a cleaner also for cleaning between the teeth made of a pointed end to clean between teeth and a thinner material for easier insertion between the teeth.

### BRIEF DESCRIPTION OF THE DRAWINGS

FIG. 1 is a front view showing the invention;

FIG. 2 is a top view of the invention of FIG. 1;

FIG. 3 is a bottom view of the invention of FIG. 1;

FIG. 4 is a right side view of the invention of FIG. 1;

FIG. 5 is a left side view of the invention of FIG. 1; and

FIG. 6 is a rear view of the invention of FIG. 1.

### DETAILED DESCRIPTION OF THE PREFERRED EMBODIMENT(S)

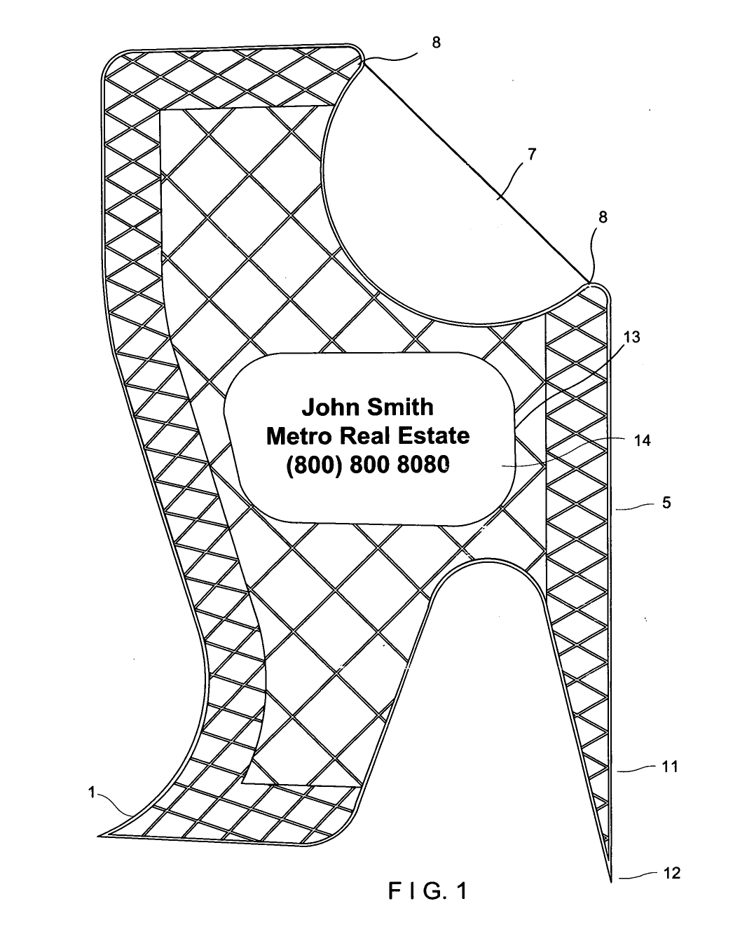

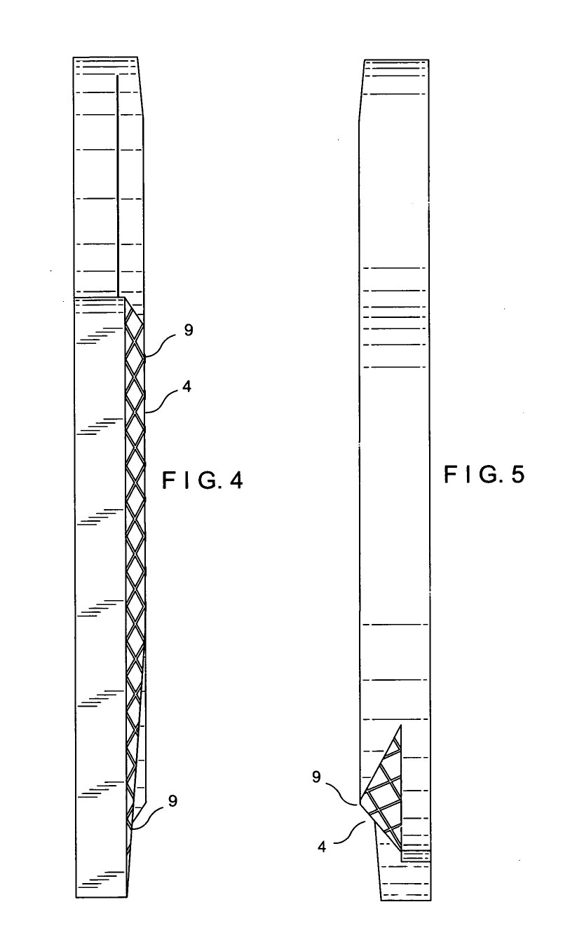

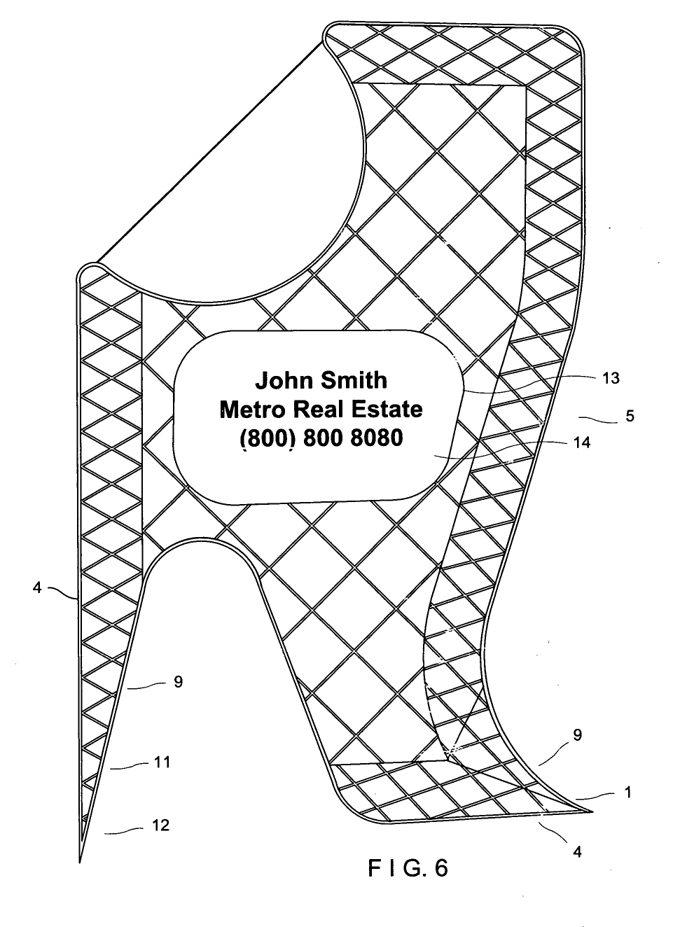

Referring now to the drawings of FIGS. 1-6, FIG. 1 shows a front view of the present invention in which it can be seen that the dental hygiene tool 5 of the present invention is preferably formed as a on piece tool 5 preferably injection molded of plastic material. The size and dimensions of the tool 5 should be approximately the same including the thickness as that of a credit card making the invention small, easy to carry and thin for use as a dental hygiene tool.

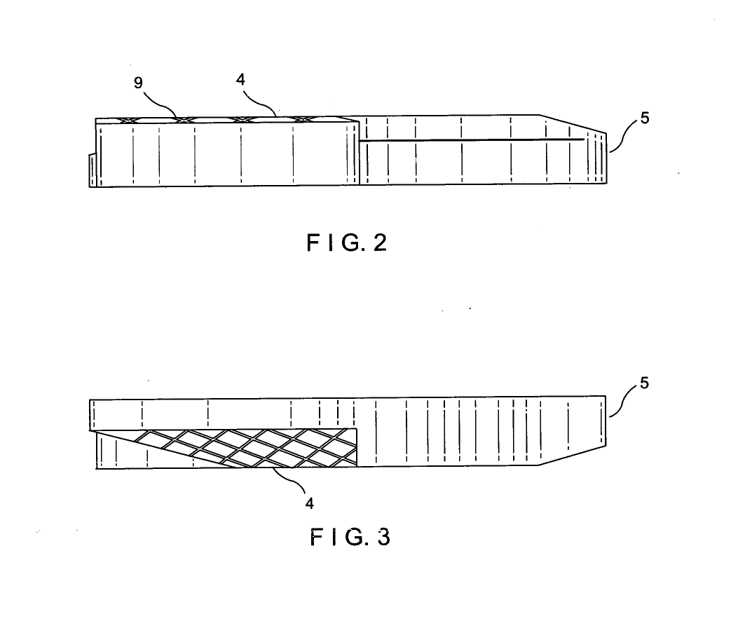

The tool 5 has several components (se FIGS. 2-6) preferably integrated or connected with the body of the tool 5. One component is a digger 6 for cleaning between teeth. Another component is a floss piece 7 preferably made of nylon and preferably attached to the tool's interiors 8. A number of rough textures 8 are provided on the tool 5 along edges 9 of the tool 5 for cleaning between the teeth of varying thicknesses depending on the spacing between the teeth. In addition the tool 5 has a curved pick portion 1 adapted to contour over a person's lip when using the tool 5. The tool also has a cleaner 11 also for cleaning between the teeth made of a pointed end 12 to clean between teeth and a thinner material for easier insertion between the teeth. By utilizing this tool the present invention provides for an efficient, inexpensive and portable method for providing dental hygiene for a person's teeth and gums. In addition the tool 5 has a center portion where a reflective surface 13 can serve as a mirror for the person using the tool to check his or her teeth for particles wedges between the teeth to see if any of the components of the tool 5 need to be used. Also a logo 14 can be placed on the center portion and on the mirror 13 to promote a business such a toothpaste company or a dentist's office. Thus the tool 5 can serve as a promotional device for business as well.

While presently preferred embodiments have been described for purposes of the disclosure, numerous changes in the arrangement of method steps and those skilled in the art can make apparatus parts. Such changes are encompassed within the spirit of the invention as defined by the appended claims.

What is claimed:

1. A dental hygiene for cleaning tool that is small, inexpensive and lightweight to use by people to care for their teeth and gums, comprising:
a dental hygiene cleaning tool formed of a lightweight material having several components integrated or connected with a body of said tool, said components including a digger for cleaning between teeth; a number of rough textures along edges of said body for cleaning between the teeth of varying thicknesses depending on a spacing between the teeth; and a curved pick portion adapted to contour over a person's lip when using the tool.

2. The tool according to claim 1 wherein said components are integrated with said body of said tool.

3. The tool according to claim 2 wherein said tool is manufactured by injection molding as tool with said integrated components

4. The tool according to claim 1 wherein said components include a cleaner also for cleaning between the teeth made of a pointed end to clean between teeth and a thinner material for easier insertion between the teeth.

5. The tool according to claim 1 wherein said components include a floss piece made of nylon and attached to interiors of said tool.

6. The tool according to claim 1 further comprising a center portion wherein a reflective surface serves as a mirror for the person using the tool to check his or her teeth for particles wedges between the teeth to see if any of the components of the tool need to be used.

7. The tool according to claim 6 wherein a logo 14 is placed on the center portion and on the mirror 13 to promote a business so that said tool serves as a promotional device for a business

8. A method for providing dental hygiene for people to care for their teeth and gums, comprising:
Providing a dental hygiene cleaning tool formed of a lightweight material having several components integrated or connected with a body of said tool, said components including a digger for cleaning between teeth; a number of rough textures along edges of said body for cleaning between the teeth of varying thicknesses depending on a spacing between the teeth; and a curved pick portion adapted to contour over a person's lip when using the tool.

9. The method according to claim 8 wherein said components are integrated with said body of said tool.

10. The method according to claim 9 wherein said tool is manufactured by injection molding as tool with said integrated components

11. The method according to claim 8 wherein said components include a cleaner also for cleaning between the teeth made of a pointed end to clean between teeth and a thinner material for easier insertion between the teeth.

12. The method according to claim 8 wherein said components include a floss piece made of nylon and attached to interiors of said tool.

13. The method according to claim 8 wherein these components include: a floss piece preferably made of nylon and preferably attached to the tool's interiors.

14. The method according to claim 8 further comprising a center portion wherein a reflective surface serves as a mirror for the person using the tool to check his or her teeth for particles wedges between the teeth to see if any of the components of the tool need to be used.

15. The method according to claim 8 wherein a logo is placed on the center portion and on the mirror 13 promote a business so that said tool serves as a promotional device for a business
